(19) United States
(12) Patent Application Publication
(10) Pub. No.: US 2008/0189997 A1
(43) Pub. Date: Aug. 14, 2008

(54) HAND-HELD REFLECTIVE SIGNALLING CARD

(76) Inventor: James A. Lucker, Meridian, ID (US)

Correspondence Address: DYKAS, SHAVER & NIPPER, LLP, P.O. BOX 877, BOISE, ID, 83701-0877, US

(21) Appl. No.: 11/672,769

(22) Filed: Feb. 8, 2007

(51) Int. Cl. G09F 21/02

(52) U.S. Cl. 40/586

(57) ABSTRACT

A hand-held, reflective signaling device made up of a card having a first and second side, each of which contain symbols and reflective portions. Each of the symbols represents a potential request for service by the card holder. The cardholder displays to approaching traffic or other passersby the side of the card containing the symbol matching the cardholder's current request for service, e.g., the request for taxi service. In doing so, the cardholder indicates his or her request for service in a clear, highly visible, and unambiguous manner. The device does not require batteries, light sources, or electrical circuitry. Further, due to its credit-card-like shape, the cardholder can keep the device close at hand in a wallet or purse.

### BACKGROUND OF THE INVENTION

1. Field of the Invention

The present invention generally relates to hand-held, reflective devices for signaling others and, more particularly, to a hand-held, reflective signaling card containing two sides, each with a symbol and a reflective portion.

2. Background Information

Oftentimes it is rather difficult to flag down a taxi or grab the attention of a driver of some other public transportation vehicle, particularly at night or in other circumstances of low visibility. This is at least partially because not every pedestrian raising his or her hand is doing so to order a taxi or stop a bus and because whistling is a short-lived signal that can easily go unnoticed by the intended target. Therefore, what is needed is a signaling device that can be easily carried by a person and that can be used to unambiguously signal an approaching driver or other passerby to the request for services by the device holder. What is also needed is a signaling device that not only unambiguously signals the device holder's request, but does so in a highly visible manner without the need for batteries, light bulbs, or electronic circuitry.

Therefore, it is an object of this invention to provide a hand-held, reflective signaling device that can be carried by the user in a purse or wallet, along with credit cards, identification cards, or business cards, and which will unambiguously signal the device holder's request for service (e.g., the request for taxi service or the request for emergency services). It is a further object of the invention to provide such a device that is configured to allow the holder to use the device to signal either of two requests by the holder.

Additional objects, advantages, and novel features of the invention will be set forth in part in the description, which follows, and in part will become apparent to those skilled in the art upon examination of the following or may be learned by practice of the invention. The objects and advantages of the invention may be realized and attained by means of the instrumentalities and combinations particularly pointed out in the appended claims.

### SUMMARY OF THE INVENTION

The present invention is a hand-held, reflective signaling device configured to be the general size and shape of a credit card. The card allows a card holder to signal approaching motorists or other passersby of the cardholder's current request for service. Due to its size and shape, the card can be easily carried by the card holder in a wallet or purse along with credit or identification cards.

The card has two sides, each of which has a symbol that, when displayed by the cardholder to approaching motorists or passersby, signals the holder's request for service. In one embodiment the symbol on the first side of the card is designed to indicate the cardholder's request for taxi service while the signal on the second side of the card is designed to indicate the cardholder's request for emergency services. Thus, in a particular configuration for this first embodiment, the symbol on the first side of the card is in the shape of a large letter “T,” and the symbol on the second side of the card is in the shape of a large letter “E.” The first embodiment could be further configured such that the symbol on the first side would be of a first color, while the symbol of the second side would be of second color. For example, in one configuration, the symbol on the first side is generally yellow while the symbol on the second side is generally light blue. More particularly, in one configuration, the symbol on the first side is Yellow—116, pursuant to the Manual on Uniform Traffic Control Devices (MUTCD), while the symbol on the second side is Blue—294, pursuant to the MUTCD.

Both sides of the card, in addition to displaying symbols, have reflective portions. Therefore, when the cardholder holds the card to approaching motorists, the reflection of the card catches the eye of the motorist or passerby and alerts him or her to the request for services by the cardholder. In one embodiment the reflective portions of both sides of the card are made up of reflective film. In a particular configuration, the reflective film has a coefficient of retroreflection of between 10 and 60. The reflective film on the first side of the card need not be the same reflective film on the second side and need not have the same coefficient of retroreflection. Therefore, in a more particular configuration, the reflective film on the first side of the card has a coefficient of retroreflection of 60 while the reflective film on the second side of the card has a coefficient of retroreflection of 10. In another particular configuration, the reflective portion of each side of the card would correspond to the portion of each side containing the symbol such that the only reflective portion of each side of the card is the area encompassing each side's symbol.

Finally, in another embodiment, the card is made of a flexible material.

The purpose of the foregoing summary is to enable the United States Patent and Trademark Office and the public generally, especially the scientists, engineers, and practitioners in the art who are not familiar with patent or legal terms or phraseology, to determine quickly from a cursory inspection the nature and essence of the technical disclosure of the application. The abstract is neither intended to define the invention of the application, which is measured by the claims, nor is it intended to be limiting as to the scope of the invention in any way.

Still other objects and advantages of the present invention will become readily apparent to those skilled in this art from the following detailed description, wherein I have shown and described only the preferred embodiment of the invention, simply by way of illustration of the best mode contemplated by carrying out my invention. As will be realized, the invention is capable of modification in various obvious respects all without departing from the invention. Accordingly, the drawings and description of the preferred embodiment are to be regarded as illustrative and not restrictive in nature.

### BRIEF DESCRIPTION OF THE DRAWINGS

FIG. 1 is a plan view of the first side of the card in a preferred first embodiment of the present invention.

FIG. 2 is a plan view of the second side of the card in a preferred first embodiment of the present invention.

### DESCRIPTION OF THE PREFERRED EMBODIMENT

While the invention is susceptible of various modifications and alternative constructions, a preferred first embodiment thereof has been shown in the drawings and will be described below in detail. It should be understood, however, that there is no intention to limit the invention to the specific form depicted, but, to the contrary, the invention is to cover all modifications, alternative constructions, and equivalents falling within the spirit and scope of the invention as defined in the claims.

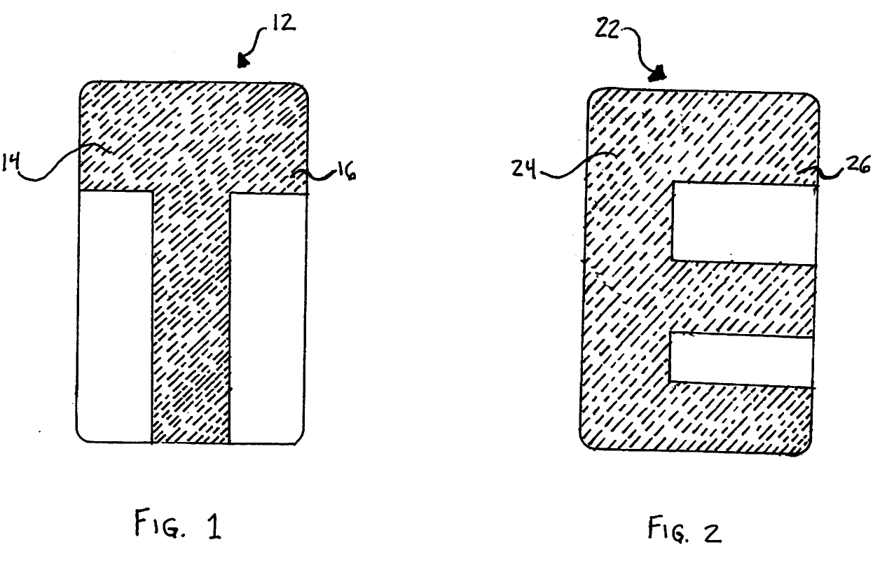

FIGS. 1 and 2 show plan views of the two sides of the card in a preferred first embodiment of the present invention. Referring first to FIG. 1, a plan view of the first side of the card comprising the present invention is shown. While in this Figure the first side symbol shown is a large letter “T” and while the reflective portion shown is limited to the area encompassing the first side symbol, it is to be understood that the embodiment shown in this Figure is merely intended to be illustrative. The invention is not limited thereto, but may be variously embodied to have a different symbol or to have a differently-configured reflective portion. Referring to FIG. 2, a plan view of the second side of the card comprising the present invention is shown. As with FIG. 1, while FIG. 2 shows a second side symbol being a large letter “E” and while the reflective portion shown is limited to the area encompassing the second side symbol, it is to be understood that the embodiment shown in this Figure is merely intended to be illustrated. The invention is not limited thereto, but may be variously embodied to have a different symbol or to have a differently-configured reflective portion.

The hand-held, reflective signaling device is made up of a card having a first side 12 and a second side 22.

The first side 12 contains a first side symbol 14 and a first reflective portion 16. In this embodiment, the first reflective portion 16 is limited to the area of the first side 12 comprising the first side symbol 14. Further, in this embodiment, the first side symbol 14 is configured into the shape of a large letter “T.” Thus, in this embodiment, the first side symbol 14 has been configured to indicate the cardholder's request for taxi service.

The second side 22 contains a second side symbol 24 and a second reflective portion 26. In this embodiment, the second reflective portion 26 is limited to the area of the second side 22 comprising the second side symbol 24. Further, in this embodiment, the second side symbol 24 is configured into the shape of a large letter “E.” Thus, in this embodiment, the second side symbol 24 has been configured to indicate the cardholder's request for emergency services.

While there is shown and described in the present preferred embodiment of the invention, it is to be distinctly understood that this invention is not limited thereto but may be variously embodied to practice within the scope of the following claims.

I claim:

1. A hand-held, reflective signaling device comprising:
a card generally the size and shape of a credit card having a first side and a second side, the first side containing a first side symbol, the second side containing a second side symbol, the first side having a first reflective portion, and the second side having a second reflective portion, wherein a cardholder can display the first side to approaching motorists or passersby to signal a first request for services by the cardholder and can display the second side to approaching motorists or passersby to signal a second request for services by the cardholder.

2. The hand-held, reflective signaling device of claim 1, wherein the first side symbol is a symbol configured to signal the first request for services by the cardholder.

3. The hand-held, reflective signaling device of claim 2, wherein the first request for services by the cardholder is the cardholder's request for taxi service.

4. The hand-held, reflective signaling device of claim 2, wherein the first side symbol is in the general shape of the letter “T.”

5. The hand-held, reflective signaling device of claim 2, wherein the first side symbol is of a first color.

6. The hand-held, reflective signaling device of claim 1, wherein the second side symbol is a symbol configured to signal the second request for services by the cardholder.

7. The hand-held, reflective signaling device of claim 6, wherein the second request for services by the cardholder is the cardholder's request for emergency services.

8. The hand-held, reflective signaling device of claim 6, wherein the second side symbol is in the general shape of the letter “E.”

9. The hand-held, reflective signaling device of claim 6, wherein the second side symbol is of a second color.

10. The hand-held, reflective signaling device of claim 1, wherein the first side has a first reflective portion.

11. The hand-held, reflective signaling device of claim 10, wherein the first reflective portion comprises a reflective film.

12. The hand-held, reflective signaling device of claim 11, wherein the reflective film has a coefficient of retroreflection of between 10 and 60.

13. The hand-held, reflective signaling device of claim 1, wherein the second side has a second reflective portion.

14. The hand-held, reflective signaling device of claim 13, wherein the second reflective portion comprises a reflective film.

15. The hand-held, reflective signaling device of claim 14, wherein the reflective film has a coefficient of retroreflection of between 10 and 60.

16. The hand-held, reflective signaling device of claim 1, wherein the card is made of a flexible material.

17. A hand-held, reflective signaling device comprising:
a card generally the size and shape of a credit card having a first side and a second side, the first side containing a first side symbol configured to signal a cardholder's first request for services; the second side containing a second side symbol configured to signal the cardholder's second request for services; the first side having a first reflective portion comprising a first reflective film having a retroreflection of between 10 and 60; the second side having a second reflective portion comprising a second reflective film having a retroreflection of between 10 and 60; the card being generally the size of a credit card; and wherein a cardholder can display the first side to approaching motorists or passersby to signal the first request for services by the cardholder and can display the second side to approaching motorists or passersby to signal the second request for services of the cardholder.

18. The hand-held, reflective signaling device of claim 17, wherein the first request for services by the cardholder is the cardholder's request for taxi service.

19. The hand-held, reflective signaling device of claim 17, wherein the first side symbol is in the general shape of the letter “T.”

20. The hand-held, reflective signaling device of claim 17, wherein the first side symbol is of a first color.

21. The hand-held, reflective signaling device of claim 17, wherein the second request for services by the cardholder is the cardholder's request for emergency services.

22. The hand-held, reflective signaling device of claim 17, wherein the second side symbol is in the general shape of the letter “E.”

23. The hand-held, reflective signaling device of claim 17, wherein the second side symbol is of a second color.

24. The hand-held, reflective signaling device of claim 17, wherein the card is made of a flexible material.

25. A hand-held, reflective signaling device comprising:
a card generally the size and shape of a credit card having a first side and a second side, the first side containing a large letter “T” configured to signal a cardholder's request for taxi service, the large letter “T” being of a generally-yellow color, the second side containing a large letter “E” configured to signal the cardholder's request for emergency services, the large letter “E” being generally of a generally-light blue color; the first side having a reflective portion comprising a first reflective film having a retroreflection of between 10 and 60; the second side having a second reflective portion comprising a second reflective film having a retroreflection of between 10 and 60; the card being generally the size of a credit card; the card being of a flexible material; and wherein the a cardholder can display the first side to approaching motorists or passersby to signal the cardholder's request for taxi service and can display the second side to approaching motorists or passersby to signal the cardholder's request for emergency services.

26. The hand-held, reflective signaling device of claim 25, wherein the generally-yellow color is Yellow—116, pursuant to the Manual on Uniform Traffic Control Devices.

27. The hand-held, reflective signaling device of claim 25, wherein the generally-light blue color is Blue—294, pursuant to the Manual on Uniform Traffic Control Devices.
